(19) United States
(12) Patent Application Publication
(10) Pub. No.: US 2010/0223108 A1
(43) Pub. Date: Sep. 2, 2010

(54) SYSTEM AND METHOD FOR MANAGING LEGAL SERVICE PROVIDERS

(76) Inventor: Thomas F. Quinn, JR., Lexington, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/682,810

(22) PCT Filed: Oct. 14, 2008
(86) PCT No.: PCT/US08/79805

§ 371 Date: Apr. 13, 2010

Related U.S. Application Data
(60) Provisional application No. 60/979,928, filed on Oct. 15, 2007.

(51) Int. Cl. G06Q 10/00; G06Q 99/00; G06Q 50/00

(52) U.S. Cl. 705/11; 705/32; 705/347; 705/348

(57) ABSTRACT

This invention generally relates to a computer system and method for objectively analyzing the quality and cost of work performed by legal service providers. Price and quality of legal service providers can be compared to various benchmarks for by industry, region, complexity, corporate targets and the like. A user of the system can analyze the cost and quality of a corporation's legal counsel and offer suggestions and solutions that resolve issues identified by the system.

### CROSS-REFERENCE TO RELATED APPLICATION

This application claims the benefit of U.S. Provisional Application No. 60/979,928 filed on Oct. 15, 2007, the disclosure of which is incorporated herein by reference.

### FIELD OF THE INVENTION

This invention generally relates to a system and method for managing the quality and cost of legal services.

### BACKGROUND OF THE INVENTION

In many corporations, in-house corporate counsel is responsible for managing all legal issues and matters that arise within the business. Many corporations have structured their in-house legal staffs fairly lean, with much of the overall work being sent to outside counsel. As such, one of the core capabilities required of corporate counsel is the ability to select trusted outside legal service providers. Generally, such outside counsel selections are based upon three critical criteria: outside counsel's relationship with the subject corporate client, the quality of services provided by outside counsel and the amount charged for such services.

While the relationship between outside counsel and in-house counsel may take years to develop, it is relatively easy for corporate counsel to subjectively evaluate their relationship with outside counsel. Quality of work and the amount charged for such work, on the other hand, can be very difficult to objectively determine and track. Corporate counsel is often overburdened with day to day internal legal issues and does not have the time or tools necessary to review the quality of each case or the amount charged. Corporate counsel is typically required to have a basic understanding of many different areas of law, quite often in many different regions. Having a complete understanding in all areas of law, in all regions of the world, such that the quality of legal services can be objectively assessed is nearly impossible. Knowing a fair price for such legal services can be equally as difficult, particularly when legal services are often spread out over considerable time periods, making it very difficult to track the total cost. In expensive and esoteric fields of law such as intellectual property, the problem is greatly compounded by the tremendous number of matters that corporate counsel has open at any given time.

This is why corporate counsel's “relationship” with outside counsel is so critical. A good relationship means there is an established trust that outside counsel will provide good services at a fair price. As a result, the selection of outside counsel is often based largely upon this trust, with little ongoing objective review of either the work quality or the amount charged for such work.

Accordingly, corporate counsel is in need of a system, or a third party service that offers a system, which provides an ongoing and more objective review of outside counsel's quality and price. Corporate counsel would benefit from a system that could directly compare the price and quality of one legal service provider to another based upon a review of the actual work quality and actual charges from each of the providers. Corporate counsel could also benefit if the actual quality and price of legal services could be compared to various benchmarks such as by industry, region, complexity, etc. In addition, a system would be particularly beneficial if the cost of legal services that typically take a long period of time could be predicted by analyzing actual cost information over a relatively short period of time. Furthermore, if the cost of legal services could readily be predicted, corporate counsel would greatly enjoy a system that could predict the cost of legal matters during a future time period, i.e., a system that could project a “budget” for legal matters.

In some circumstances, corporate counsel is so overwhelmed with the day to day corporate legal issues that it would be highly advantageous to have a third party service offer a system and method with the above desired benefits. This would be of particular benefit if the third party service had multiple clients and therefore had expertise that could be shared with corporate counsel. In these circumstances, such a third party service, would be, of even more benefit if it was an all inclusive service that completed an analysis of quality and cost and offered suggestions and solutions that would resolve issues identified by the system.

### SUMMARY OF THE INVENTION

The present invention includes a computer system and method for objectively analyzing the quality and cost of work performed by legal service providers. In one aspect of the present invention, a system is provided that directly compares the price and quality of one legal service provider to another based upon a review of the actual work quality and charges from each provider. In various aspects of the present invention, a system is provided for comparing the price and quality of legal service providers to various benchmarks for quality and price, such as by industry, region, complexity, corporate targets and the like. In another aspect of the present invention, a system is provided for predicting the cost of legal services that typically take a long period of time, by analyzing actual cost information over a relatively short period of time. In yet another aspect of the present invention, a system is provided that predicts a budget or estimated total cost for legal matters during a selected time period. In an alternative aspect of the invention, a third party with expertise using the system offers a service where quality and cost are analyzed and suggestions and solutions that resolve issues identified by the system are offered.

In summary, by providing these and other systems and methods of the present invention, corporate counsel's selection of outside counsel can be based upon objective quality and cost data rather than completely upon subjective trust. Additionally, corporate counsel can readily predict the cost of future legal services based upon a sampling of actual cost information, which in turn allows corporate counsel to quickly compare the performance of one legal service provider to various criteria and further allows corporate counsel to quickly estimate future costs. If desired, corporate counsel can outsource the analysis of quality and cost to a third party, who has expertise in such analysis and in the solutions that resolve identified problems.

### DESCRIPTION OF THE DRAWINGS

FIG. 1 is a flow chart depicting one embodiment of the present invention.

FIG. 2 is a flow chart depicting another embodiment of the present invention.

FIG. 3 is a flow chart depicting yet another embodiment of the present invention.

FIG. 4 is an exemplary report generated by the system in accordance with the present invention, which summarizes and compares the quality and cost for various legal service providers performing a selected service type in a selected country.

FIG. 5 is an exemplary table illustrating the number of legal matters of a certain type that are pending in various countries and which were initiated in various years, in accordance with one embodiment of the present invention.

FIG. 6 is an exemplary table illustrating the number of legal matters of another type that are pending in various countries and which were initiated in various years, in accordance with one embodiment of the present invention.

FIG. 7 is an exemplary table illustrating the target costs of legal matters that are pending in various countries and the year that such costs are anticipated, in accordance with one embodiment of the present invention.

FIG. 8 includes two exemplary tables in accordance with the principles of the present invention illustrating the projected costs for selected legal matters by the year in which the legal matters were initiated, for both targeted costs and actual costs.

### DETAILED DESCRIPTION OF THE INVENTIONS

Various aspects of the system and method of the present invention disclosed herein, along with the accompanying drawings, are intended to be exemplary and not limiting. It is understood that other embodiments may be utilized and fall within the scope of the appended claims without departing from the spirit of the invention.

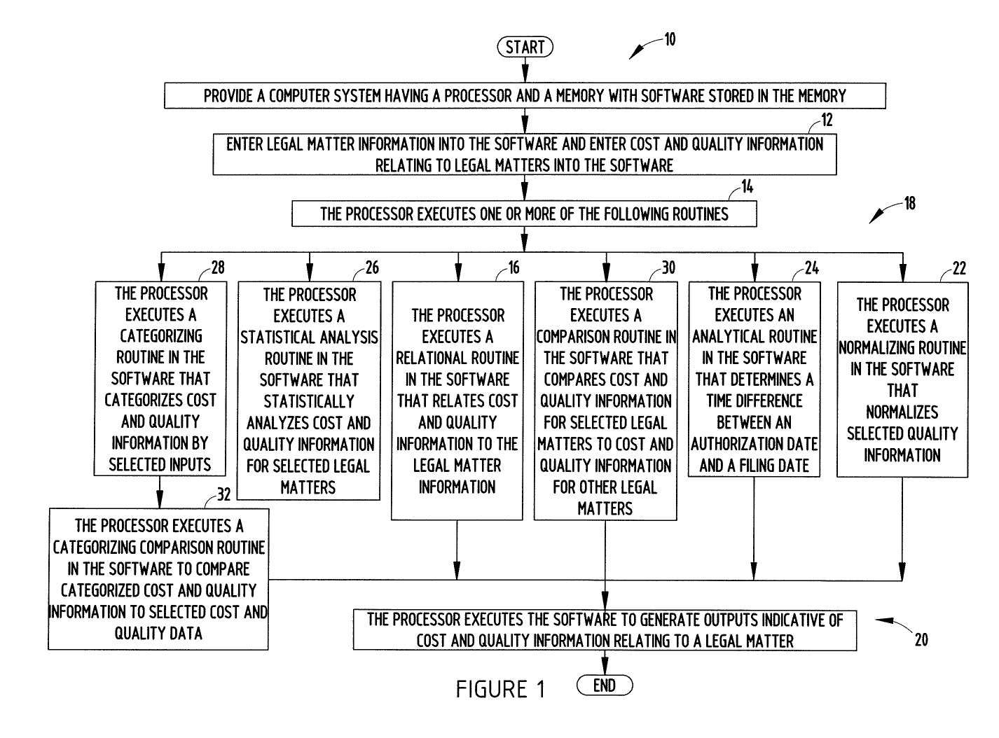

As shown in FIGS. 1 through 3, a comprehensive system and method are provided, which enable a business to manage both the quality and cost of legal services. A brief overview of how the system and method of the present invention can be used is provided herein below, followed by more specific descriptions of various aspects.

The system and method of the present invention, hereinafter the “system” is used to assist in the management of the quality and cost of legal services. The system can be used in conjunction with legal matter and cost management tools such as those disclosed in International application number PCT/US 2007/064062 filed on Mar. 15, 2006 by applicant Thomas F. Quinn, Jr., which is incorporated herein by reference and has the same inventor as the present invention.

In one aspect of the present invention, the system is used to evaluate the quality of legal services. To evaluate the quality of legal services, the results and work of legal service providers is analyzed and given a quality rating. The quality ratings are entered into the system along with the legal matters to which these quality ratings relate. Quality ratings can then be tracked, averaged, compared, reported and the like for the various legal matters. While the system may be somewhat subjective, the system clearly identifies under performing legal service providers with below average quality that require immediate attention. Likewise, strong performers are also quickly identified. As such, a user of the system can distribute legal work accordingly.

In another aspect of the present invention, the system is used to predict the typical cost of legal services over the life of a typical legal matter. First, legal matter information and actual charges relating to legal matters are entered into the system. The actual charges are entered from a selected time period or “sampling period” that can be less than the life of a typical legal matter. The system relates each actual charge to a specific legal matter. The system then calculates the amount of time that has passed from an initiation date of the specific legal matter until the date of the actual charge. The system makes this calculation for multiple legal matters and uses the information to determine typical charges and the time when such typical charges occur over the life of a typical legal matter. As a result, the system can predict the amount of, and time when, typical charges will occur over the life of selected legal matters.

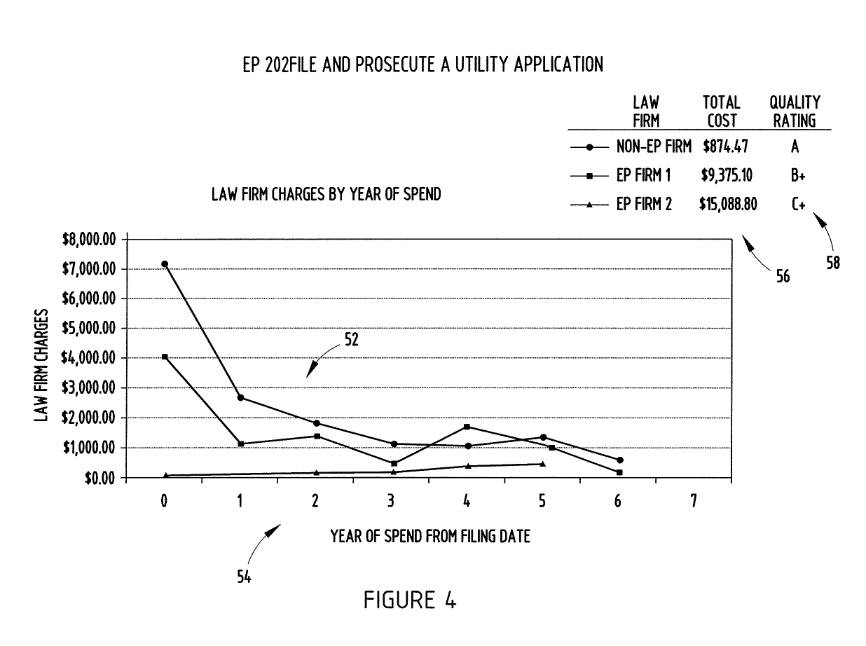

As shown in FIG. 4, when quality ratings and estimated typical charges are determined for selected legal service providers, they can be directly compared to one another in order to determine the most efficient provider. An advantage of the system of the present invention is that cost comparisons can be completed relatively quickly. The system does not require actual charges over the entire life of legal matters in order to estimate the total cost. Rather, when the typical life of a legal matter is several years or more, a much shorter sampling period can be evaluated to estimate the total cost.

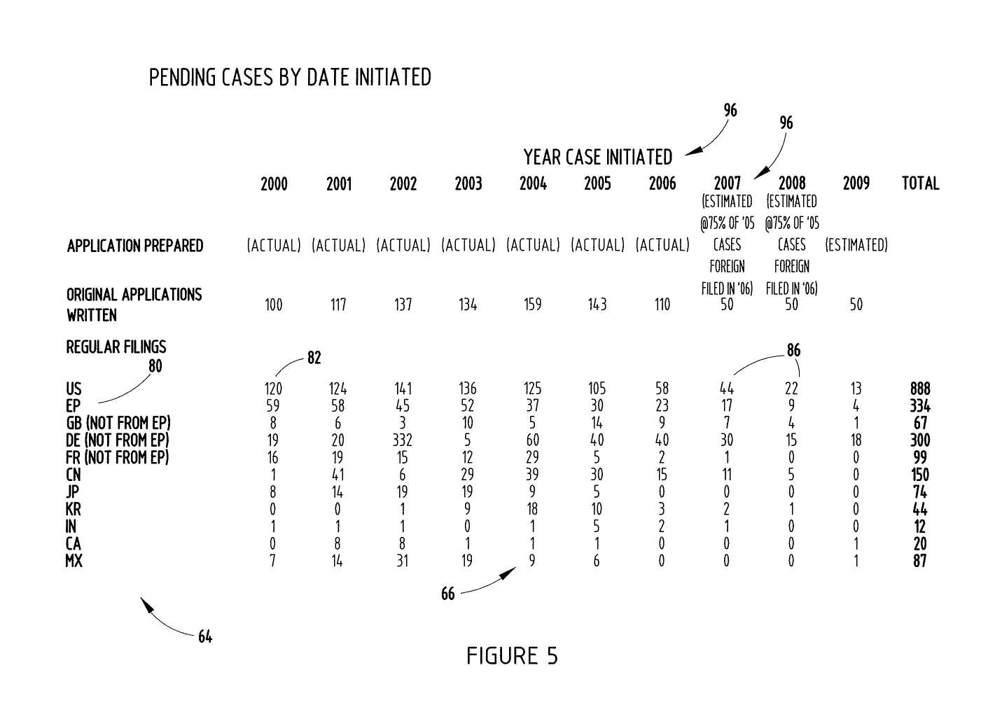

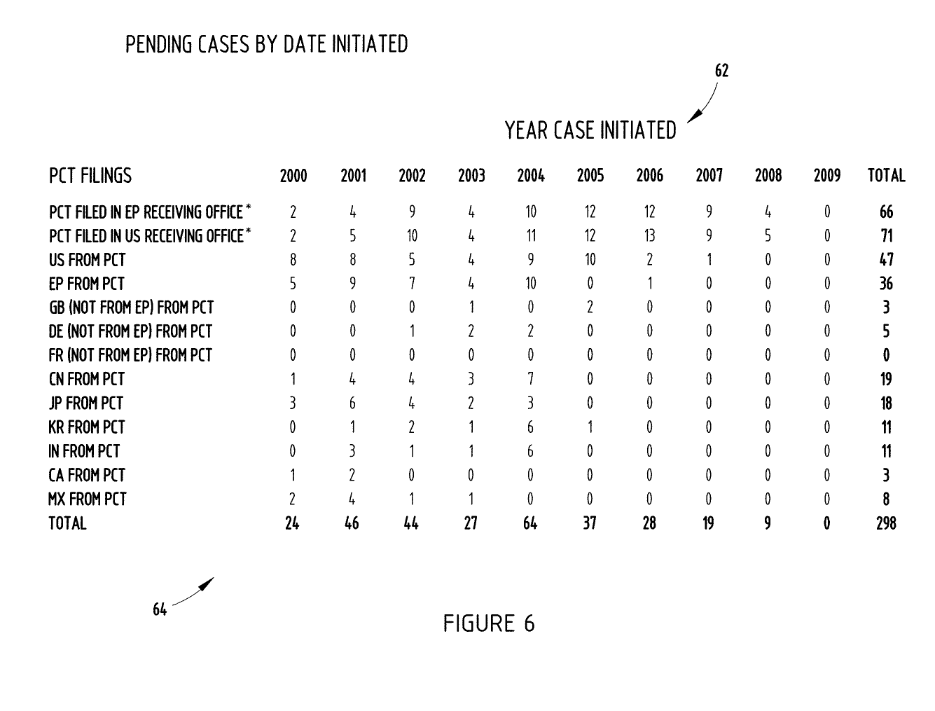

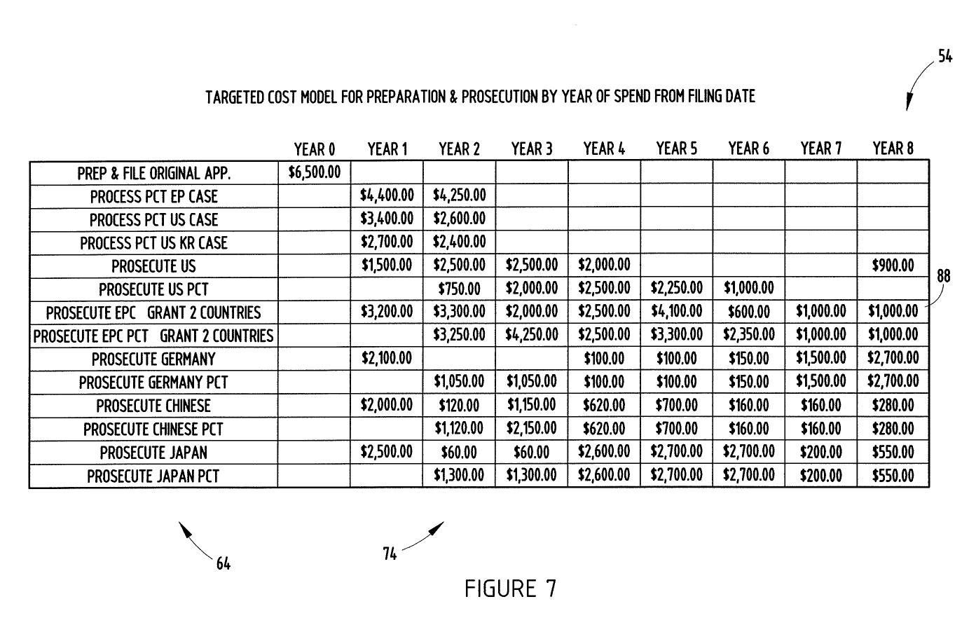

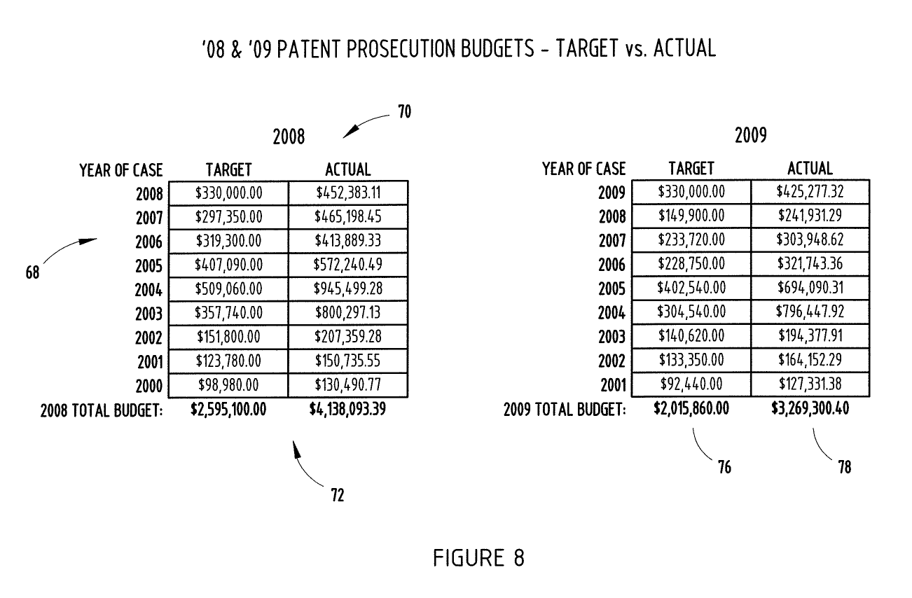

In another aspect of the present invention, once typical charges are known as a function of time, future budget estimates can be determined In other words, when the date of initiation of all pending legal matters is known, and the tuning of typical charges is known, then the total cost for these matters can be estimated for any selected budget period. In short, the system estimates the total charges for pending legal matters of various ages. The system does this by multiplying the number of pending matters of a certain age, see FIGS. 5 and 6, by the applicable typical charge that is expected to occur during the selected budget period, see FIG. 7. This process is repeated for legal matters of all ages and the sum provides a total estimate for a selected budget period, see FIG. 8. Accordingly, a budgeted amount can be estimated for multiple legal matters during a selected time period. Alternatively, budgeted amounts can also be estimated for selected legal matters over the life of the matters. In either case, the budget amount is based upon actual charges for legal matters, rather than a legal service provider quote or some other type of speculative estimate.

In addition to evaluating the cost and quality of legal services and estimating budgets, another aspect of the system of the present invention is to use actual charges for tracking legal service costs by various parameters such as legal service provider, industry, complexity of the matter, matter type, region and the like. Actual data can be gathered from a number of users of the system and statistical data can be shared. Likewise, the system can also be used to benchmark legal cost and quality by the parameters listed above. An advantage of this system is that benchmarks can be determined for all countries and service types, by using relatively short sampling periods. A further advantage is that with these relatively short sampling periods, any bias due to currency fluctuation and inflation is minimized. Moreover, even rare countries and service types can be benchmarked quickly because data from multiple clients can be entered, compared and shared. Data can also be shared with legal service providers seeking certification that they meet benchmarked quality and cost standards. Use of the system can also be outsourced to a service provider that has expertise in the use of such systems, such as TIPS Invoice Processing Systems, LLC located at 3061 Commerce Drive, Suite 1, Fort Gratiot, Mich. 40059. Any such service provider would offer all of the analysis above and could also provide recommendations on how to resolve problems that are identified.

Various embodiments of this system will be disclosed in greater detail herein below.

In one embodiment of the present invention, the system 10 is a computer system having a processor, a memory associated with the processor and a software system stored in the memory. The system is adapted to receive an input 12 or “data”, which includes legal matter information as well as cost and quality information relating to the legal matter information. The system of the present invention may be used in conjunction with a system as disclosed in International patent application PCT/US 2007/064062 filed on Mar. 15, 2006 by applicant Thomas F. Quinn, Jr., which is incorporated herein in its entirety by reference. Data and routines from both systems can be related and shared.

Legal matters are work projects requiring legal services and typically include, but are not limited to matters relating to contracts, law suits, investigations, secrecy agreements, sales and acquisitions, employee issues and other common legal matters, including but not limited to those listed by the Uniform Task Based Management System, which can be obtained on their website at www.UTBMS.com, which is also hereby incorporated by reference. More particularly, intellectual property related legal matters could include patents, trademarks, copyrights, trade secrets, intellectual property related opinions, intellectual property related litigation, intellectual property related contracts, intellectual property related investigations, intellectual property related searches, intellectual property related watches, intellectual property related appeals, intellectual property related annuities, intellectual property related merger and acquisition work, intellectual property related oppositions and intellectual property related renewals.

Legal matter information or data that might typically be entered into the system 10 for one specific legal matter includes, but is not limited to a title, key words, matter reference number or “control number”, business contacts, contact information, law firm, attorney, matter type, matter status, related technology, related industry, complexity of the matter, country or region, business budget information, critical dates, reminder dates, third parties involved in the matter, budget amount for a legal matter, budget amount for a service type, cost target for a service type, patent number, trademark number, serial numbers, number of words in a patent application, asset owner, filing date, authorization date, initiation date, stop all work date, matter completion date, inventors, terminated attorneys, team member attorneys working on a legal matter, accounting data, budget related information, cost target information, banking information, company information, the business unit or division financially responsible for a legal matter or asset, and the like.

In addition the system 10 receives quality information relating to these legal matters as an input. The system executes 14 a relational routine 16 that relates the quality information to the legal matter information. This can be accomplished by identifying each legal matter in the system with a unique identifier. For example, general matters are quite often identified by a unique legal matter reference number. Alternatively, intellectual property matters are quite often identified by a unique combination of a legal matter reference number or “family number” and a country where the matter is active. Likewise, all quality information entered into the system is also identified by the same unique identifier. As such the relational routine 16 in the software can relate each item of quality information to a specific legal matter.

In various embodiments of the present invention, conventional relational database software such as Microsoft Access, Microsoft SQL Server, Oracle, DB2, and the like can be used to receive the various inputs, create the various routines, and generate the various outputs herein, including the relational routine 16. The processor executes the routines within the software and generates outputs. Once the relational routine 16 relates the quality information to the legal matter information, the system 10 can execute additional routines 18 and generate various outputs 20 indicative of the quality information as it relates to selected legal matter information.

Quality information can include subjective information such as a quality rating, a quality grade and the like. Subjective quality information can be provided by quality reviewers that have reviewed legal work relating to a specific legal matter. In one embodiment of the present invention, subjective quality information relating to intellectual property is provided by one or more quality reviewers such as patent attorneys, inventors, patent translators, employees of a company related to an assignee of a patent, technical experts and the like. For example, a quality reviewer such as a translator or technical expert may initially review legal work to identify legal matters where the work associated therewith requires further review. The resulting quality ratings can be entered into the system 10 without further review. Alternatively, in a more detailed analysis, the legal work can be further reviewed by a patent attorney or an employee of the company, before an additional or ultimate quality rating is provided. In any event, quality ratings may include several categories, which for intellectual property matters include but are not limited to, technical writing, claim writing, claiming, strategy, claim structure, completeness, and the like.

In order to reduce the subjectivity of such information, a normalizing routine 22 is used to normalize quality ratings and the like by individual quality reviewers. Conventional grading techniques can be used to normalize quality information from one reviewer to another. In one embodiment of the present invention, the system 10 calculates an individual reviewer's average quality rating for a number of legal matters. Each quality rating by that individual is then normalized by calculating its variance from the average quality rating. For example, if a reviewer's average quality rating on a scale of one to ten is six, then an absolute rating of eight would generate a normalized rating of positive two. If that same reviewer gave an absolute rating of five, the normalized rating would be negative 1. Similarly, if another reviewer's average rating was three, an absolute rating of five would result in a normalized rating of positive two and so on. Normalized ratings from multiple quality reviewers can then be combined for analysis, sorting, grouping, comparison and the like.

Quality information may also include objective information such as success rates, recovery amounts, timeliness of legal work, and the like. In one embodiment of the present invention, the system uses objective quality information to determine an output. For example, the system 10 uses an analytical routine 24 to calculate the time difference between an authorization date for a specific legal matter and a completion date. Referring again to an intellectual property example, the system 10 calculates a time difference between the date when the legal service provider was instructed to file a patent application, and the filing date when the legal service provider actually filed the patent application. This system 10 then calculates a typical time difference for a number of legal matters, for example, the system 10 calculates an average time difference between authorization and filing.

This calculation is completed for various legal service, providers. The typical time difference for one service provider can then be directly compared to another service provider. A legal service provider that regularly takes much more time to file patent applications than other service providers will be readily detected by a user of the system. The user can then advise a person managing the legal service provider of the problem and offer suggestions and solutions on how to correct the issue or redistribute the work to another legal service provider.

As set forth in the time difference example above, the system 10 of the present invention uses a statistical analysis routine 26 that is capable of calculating a statistical average for quality information relating to selected legal matters. Similarly, the statistical analysis routine 26 is also capable of conducting other conventional statistical analysis on quality data and generating outputs 20 with respect to selected legal matters. For example, the mean, median, high, low, standard deviation and the like for various types of quality information can be calculated as well as a count of the applicable selected legal matters being analyzed. Similarly, the statistical analysis routine 26 can also determine typical success rates, typical recovery amounts, typical timeliness and the like for use in generating various quality rating outputs 20.

The system 10 of the present invention can also include a categorizing routine 28 that categorizes outputs, such as the statistical analysis above, by various parameters. For example, average quality ratings can be categorized by legal service providers. In another example, average quality ratings for legal service providers can be categorized by region or industry. In summary it may be desirable for a user of the system 10 to categorize quality information by numerous parameters including but not limited to service type, legal service provider, law firm, attorney, industry, technology, region where the law firm is located, region where the work is being performed, a complexity rating of the legal matter and the like.

The system of the present invention can also include a comparison routine 30 that compares quality information. For example, the average quality rating for a selected legal service provider can be compared to the average quality rating for another legal service provider. It may be also be desirable for a user of the system 10 to execute a categorizing comparison routine 32 that compares categorized quality information to various comparison data including but not limited to quality rating outputs for other selected legal matters, quality rating outputs for other selected legal service providers, target quality information, benchmarked quality information, average quality information, and the like.

In another aspect of the present invention, the system 10 can also receive legal cost data relating to the legal matters as an input 34. Cost data can include all of the information that might typically be found in an invoice for legal services with charges on one or more legal matters. This includes, but is not limited to, invoice number, invoice date, billing time period, exchange rate, invoice total amount due, client legal matter reference number, country, attorney legal matter reference number, service type, law firm, attorney, service date or “charge date”, a detailed description of services provided, attorney time, attorney hourly billing rate, attorney amount or “charge”, expense type, expense date, which can also be referred to as a “charge date”, expense amount, which can also be referred to as a “charge”, and the like. As with the quality information, each item of cost information is uniquely related to legal matter information. As such, each item of cost information must include unique identifiers that relate it to a specific legal matter. As shown in FIG. 4, the system 10 of the present invention can generate an output 20 indicative of cost information in combination with quality information, which both relate to selected legal matters.

In accordance with the principles of the present, invention, with cost information and legal matter information entered into the system 10 as inputs 34, and with these inputs 34 related to one another by a relational routine 36, the system 10 can be used to evaluate the cost of legal services as well. In one embodiment of the present invention, the system 10 is used to predict the typical costs of legal services over the life of a typical legal matter. As will be described in more detail hereafter, the system 10 analyzes the amount of time that passes from the initiation date of a legal matter until the date of an actual charge for that matter. The system 10 uses this analysis to predict the amount of, and time when, typical charges will occur over the life of a typical legal matter. The system 10 can also sum these typical charges to determine estimated total charges over the life of a matter. Typical charges over time and estimated total charges are generally illustrated in FIG. 4.

In short, the system 10 of the present invention uses an analytical routine 38 within the software to determine a time difference between a charge date associated with a specific charge and an initiation date associated with a specific legal matter. The system 10 uses a categorizing routine 40 to categorize specific charges and the time differences relating thereto, by selected legal matter information. The system 10 then generates an output 42 indicative of charges and time differences, categorized by legal matter information.

More particularly, in one embodiment of the present invention, the categorizing routine 40 also includes an averaging routine 44 that calculates a typical charge and an estimated date when the typical charge would be, expected to occur. The averaging routine 44 determines the average charges relative to a selected time difference. For example, if there were several actual charges that were categorized by a certain time difference, the averaging routine 44 would calculate an average for these categorized charges. This average charge would be considered the typical charge associated with that certain time difference. The typical charge and the time difference can be further categorized by the legal matter.

Once typical charges and the dates they occur are known for legal matters, the system of the present invention may execute a legal matter budget routine 46. This routine 46 uses the typical charges and the estimated dates for such charges to estimate the total charge over the life of a typical matter. Once an estimated total charge is determined, the system 10 of the present invention may also use a sorting routine 48 to sort estimated total charges. This routine 48 sorts estimated total charges by one or more various parameter inputs including but not limited to matter type, service type, legal service provider, law firm attorney, industry, technology, region where the law firm is located, region where the work is being performed, a complexity rating of the legal matter and the like. In addition, the system 10 of the present invention may also use a sorted comparison routine 50 to compare the sorted estimated total charges to various parameter inputs including but not limited to another sorted total estimated charge generated by the system 10, an average sorted estimate of total charges generated by the system 10, a benchmark for sorted total estimated charges, a target for sorted total estimated charges, and the like.

For purposes of illustration, a specific example will be set forth where the execution of each of the relevant routines 38, 40, 44, 46, 48 and 50 will be applied and described. The results of this example are shown in FIG. 4. In the example, the charges being analyzed are by two European and one non-European law firm, which relate to patent prosecution matters in the European Patent Office or “EP”. In one embodiment of the present invention, the analytical routine 38 is used to determine the time difference between each charge relating to EP patent prosecution and the related filing date for each EP patent application. The categorizing routine 40 is used to categorize these charges by their respective time differences. More particularly, the categorizing routine 40 includes an averaging routine 44 that calculates the average charge, for the charges categorized by their respective time difference. This calculation is repeated for all of the time differences. The system 10 then generates an output 42 as shown in FIG. 4, illustrating the typical charges and estimated dates when the typical charges would be expected to occur for the prosecution of a typical EP patent application. In other words, the typical charges are shown for EP prosecution, categorized by the amount of time after the filing date. Kindly note that the example in FIG. 4 is further categorized by various law firms. As can be seen by the graph portion of FIG. 4, EP Firm 2 is regularly charging significantly higher prices than EP Firm 1.

As can be further seen in FIG. 4, if the typical charges 52 are know as a function of time, the total charges over the life 54 of a typical matter can be estimated by the legal matter budget routine 46. This routine 46 sums the typical charges 52 over time to estimate the total charges 56 for a budgeted legal matter. In this example, the system 10 of the present invention uses a sorting routine 48 to sort estimated total charges by legal service provider. In FIG. 4, the total estimated charge 56 by EP Firm 1 is $9,375.10, and the total estimated charge by EP Firm 2 is $15,088.80. The system 10 of the present invention also uses a sorted comparison 50 routine to compare total cost information of one legal service provider to another. In other words. EP Firm 2′s total charge of $15,088.80 is directly compared to EP Firm 1′s total charge of $9,375.10 and a difference of $5,713.70 is calculated. In this example, a user of the system 10 can readily determine that EP Firm 1 is providing EP prosecution services on a more cost effective basis. Also note that in accordance with the principles of the present invention, the system 10 also generates quality ratings 58 for EP Firm 1 and EP Firm 2. This makes any management decision regarding a comparison of EP Firm 1 to EP Firm 2 even easier, as EP Firm 1 is more cost effective and is providing better quality EP prosecution.

Another advantage of the system 10 of the present invention is that if the typical charges 52 for a legal matter are known as a function of time, the typical cost during any fixture budget period can be estimated. As such, the system includes a budget period routine 60, which is somewhat similar to the legal matter budget routine 46. When this routine 60 is executed, it uses the typical charge and the estimated date, along with legal matter information, to estimate future charges for legal matters during a selected budget estimation time period. In other words, when the date 62 of initiation of all pending legal matters 64 is known as shown in FIGS. 5 and 6, the typical charges 52 that will occur during a budget period for these pending matters 64 can be estimated.

The system of the present invention estimates the total cost for pending legal matters by multiplying the number of pending matters 66 of a certain age, see FIGS. 5 and 6, by the applicable typical charge 52 that is expected to occur during the selected budget period, see FIG. 7 for a general illustration. This process is repeated for legal matters 64 of all ages 68 and the sum of the estimated total charges 70 provides a total estimate 72 for all legal matters 64 during the selected budget period, see FIG. 8. Accordingly, a budgeted amount can be estimated for legal matters during a selected future time period, where the estimate is based upon actual charges for legal matters.

As further shown in FIG. 8, if typical charges 52 are believed to be excessive, targeted charges 74 can be used to replace the typical charges 52, and the system will estimate a total budgeted amount 76 based upon these targeted charges 74. As such, by comparing the estimated budgeted amount 78 based on typical charges 54 to the estimated budgeted amount 76 based upon targeted charges 74, the system can estimate the potential savings that can be enjoyed if legal service providers are managed provide services at the targeted charges 74. For the example shown in FIG. 8, the estimated 2008 budget based upon actual charges is $4,138,093.39, while the budget based upon targeted charges 74 is $2,595,100,00. As such, the potential cost savings in 2008, if legal services providers are managed to meet the cost targets 74, is a difference of $1,542,993.39.

For the purpose of illustration, the specific example set forth above relating to charges for the prosecution of patent applications in the EP will be continued. This continued example will specifically address the execution of the budget period routine 60 and describe its application in this example. As set forth above and shown in FIG. 4, the typical charges 52 for EP prosecution by EP Firm 1 are known, as well as when these charges 52 are likely to occur from the filing date of the EP patent application. If a user of the system 10 now wants to know the estimated total cost of all patent prosecution in the EP by EP Firm 1 in a future year, e.g. 2008, the system of the present 10 invention executes the budget period routine.

The budget period routine 60 identifies all pending EP prosecution legal matters by age from their respective filing dates. As shown in FIG. 5, pending cases in the EP 80 are shown in the second row of the “Regular Filings” section. The oldest pending EP cases were initiated in the year 2000 and there are 59 EP cases 82 still pending from that group. Pending EP cases continue in each year since 2000, through the most recently filed cases. As shown in columns 84 labeled “2007” and “2008”, a user of the system can input an estimated number of future legal matters 86 as well. This is recommended when the initiation of future legal matters 86 will factor into the total estimated costs during a future budget period. In this example, the filing of future EP applications is factored into the pending legal matter table shown in FIG. 5, with seventeen estimated filings in 2007 and nine estimated filings in 2008.

If pending cases from 2000 are analyzed to determine the total estimated charges in 2008, the time difference between the future budget period, i.e. 2008, and the cases initiated in 2000 is 8 years. As such, to determine the total estimated charges in 2008 for cases initiated in 2000, the budget period routine multiplies the total number of cases initiated in 2000 by the typical charges in year 8. For purposes of illustration, if we assume that the charges 74 shown in FIG. 7 are the typical charges 52 by EP Firm 1 for EP patent prosecution matters, the total number of EP prosecution matters 80 initiated in 2008 should be multiplied by the typical charge $1000 shown in cell 88 located in the “Year 8” column and the “Prosecute EPC Grant 2 Countries” row in FIG. 7. This process is repeated for EP prosecution matters 80 initiated in 2001, 2002, etc. until all EP prosecution matters are multiplied by the typical charges expected in the 2008 budget period.

Kindly note the typical charges 52 for the EP prosecution shown in FIG. 7 includes the EP application being validated in 2 countries. Again, FIG. 7 is used in this example for illustrative purposed only, in order to show how typical charges 54 by EP Firm 1 are multiplied by the number of pending cases initiated in each year.

As is generally illustrated in FIG. 8, without reference to the actual dollar figures, the system 10 of the present invention generates an output 42 of the estimated charges in 2008 for all EP cases, by the year in which they were initiated. These totals can be summed to provide a total estimate of all charges for all EP prosecution matters during the future budget period of 2008.

The system 10 of the present invention can execute the budget period routine 60 for all legal matters 64 to estimate the total cost of legal matters in a future budget period, as well. Accordingly, users of the system can estimate their future legal spending based upon actual charges relating to their legal matters, rather than a legal service provider quote or some other type of speculative estimate. As such the system 10 of the present invention can be used as a strategic analysis tool to determine what costs will be incurred based upon the number of legal matters initiated over future time periods. In addition, users can also enter targeted charges 74 into the system 10 and determine what their future legal spending would be if legal service providers met these targeted charges. As a result, if law firms were managed to meet certain price targets, the potential savings of meeting such targets can be calculated by the system 10.

Another advantageous feature of the present invention is that the system 10 does not require entry of actual charges over the entire life of legal matters in order to estimate the total cost of a legal matter. Rather, the actual charges for a number of legal matters can be entered from a discrete time period or “sampling period” that is less than the life of a typical legal matter. As such, when the typical life of a legal matter is several years or more, a much shorter sampling period can be evaluated to estimate the total charges of legal service providers over the life of that matter.

In accordance with the principles of the present invention, the system 10 evaluates cost information from a selected cost sampling time period, which can be much less than the typical life of a legal matter. The system 10 uses this cost information to generate typical charges 52 and the time 54 when such charges are expected to occur. The larger the number of legal matters being analyzed, the smaller the sampling period can be and still allow the system 10 to generate accurate estimates of typical charges 52. As such, each of the routines executed and the outputs generated by the system 10 of the present invention can be based on actual cost information taken during the sampling period.

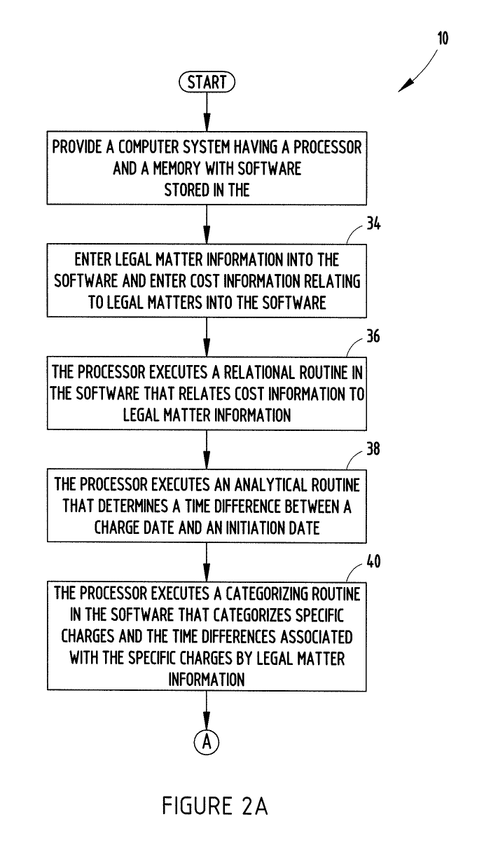

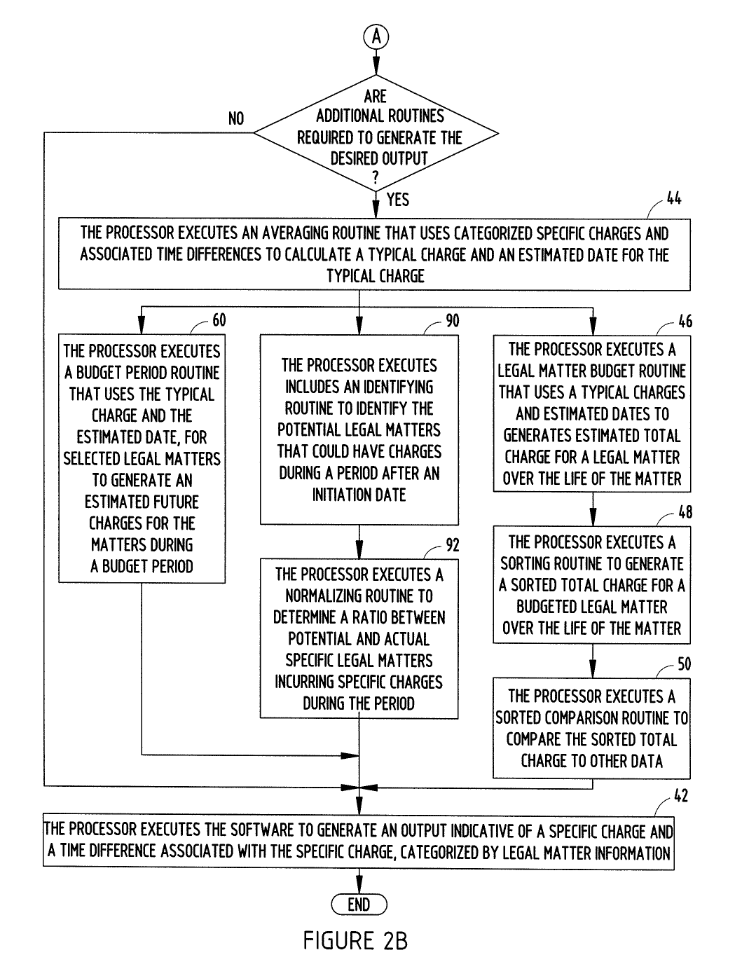

It is important that the system accurately predicts estimates of typical charges 52 and the time 54 when such charges occur. Accordingly, one embodiment of the present invention executes various routines that utilize techniques to improve the accuracy of the estimates by the system 10 when a relatively small sampling period is used. As shown in FIG. 2, an identifying routine 90 is executed to identify the potential number of legal matters which could have incurred charges during a selected time period after the initiation date. In addition, a normalizing routine 92 is executed to determine a ratio between the potential number of legal matters identified and the number of legal matters that actually incurred charges during the selected time period. This routine then uses the ratio as a factor in determining the typical charge.

For purposes of illustration, one of the techniques utilized is as follows. If there are one hundred pending legal matters that were initiated two years ago that could have incurred charges during the sampling period, and forty of those pending matters actually incurred a charge during the sampling period, the ratio would be equivalent to forty percent. If the average charge incurred on the forty cases was one thousand dollars, the typical charge would be reduced to forty percent of the average. As such the typical charge during the selected time period would be forty percent of one thousand dollars, or four hundred dollars. Likewise, if the sampling period was less than the selected time period after the initiation date, a time ratio could also be determined and factored into the calculation of typical charges. If the selected time period was twelve months and the sampling period was six months, the ratio would be two to one. As such, the typical charge of four hundred dollars could be increased by a factor of two, to eight hundred dollars. Kindly note that one of ordinary skill in the art would certainly recognize that other techniques, such as more sophisticated statistical and normalization techniques, could be utilized to improve the accuracy of the system 10.

Generating accurate estimated charges with a relatively small sampling period is highly desirable for a number of reasons. Budgets for selected legal matters can be forecasted shortly after the system 10 is in use by a user. Likewise, budgets for selected time periods can be forecasted shortly after the system 10 is in use by a user. In addition, initial evaluations can be conducted early and the typical costs charged by various legal service providers can be determined and quickly compared. As such, service providers that are charging excessive amounts can be quickly identified and managed, or terminated in favor of lower cost service providers.

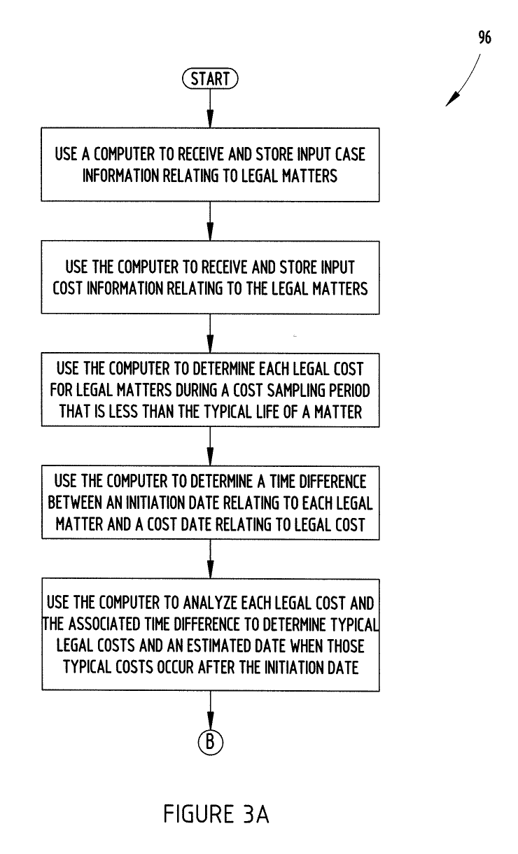

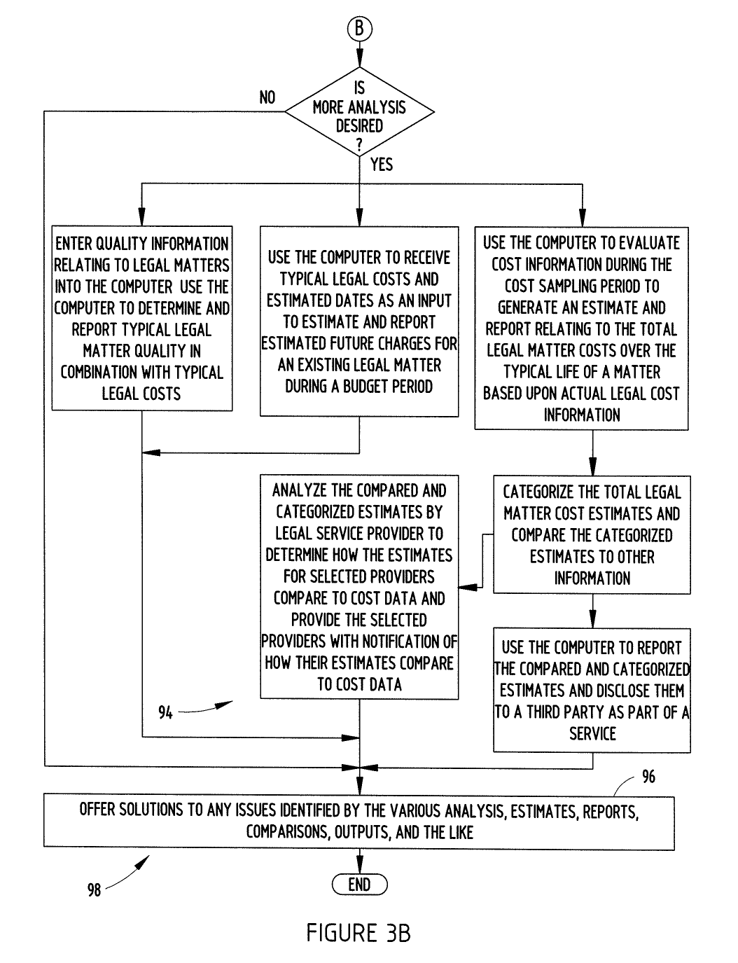

In another embodiment of the present invention shown in FIG. 3, a method of using the system 10 of the present invention is disclosed. In this method a user of the system 10 uses a computer to receive inputs 12, run the various routines and generate the various outputs disclosed hereinabove. The computer is used to analyze cost and quality information inputs relating to legal matters as set forth above.

In another embodiment of the present invention, legal service providers can be provided 94 with an output indicating how their estimated typical costs compare to established costs such as a client's target pricing, other legal service provider costs, industry standards, regional standards, benchmarks, and the like. Moreover, outputs from the system can also be shared 94 with legal service providers seeking certification that they meet benchmarked quality and cost standards.

In another embodiment of the present invention a third party can use the system 10 for multiple businesses, which increases the number of legal matters being evaluated, which in turn increases the accuracy of estimated typical charges and the speed at which such estimates are determined. Even rare countries and service types can be benchmarked quickly because data from multiple clients can be entered, compared and shared. As such, use of the system 10 can also be wisely outsourced to a third party service provider that has expertise in the use of such systems.

A third party service provider with expertise can provide all of the aforementioned uses of the system, and can also provide 96 recommendations on how to resolve cost and quality problems that are identified. Clearly the third party service provider is in a position of expertise when it has compared and benchmarked numerous other legal service providers for various businesses and has knowledge of the cost and quality rating for multiple legal service providers. Moreover, the third party would also know the cost of typical legal matters such that various legal service providers could be benchmarked. When the system 10 of the present invention is used to provide 98 cost information in combination with quality information, the system 10 becomes a very powerful tool for managing legal service providers.

As set forth above, the present invention provides a comprehensive, system for managing the cost and quality of legal services.

These and other embodiments of the present invention shall not be limited by the appended claims.

1. A computer system for assisting in the management of cost and quality on legal matters comprising:
a) a processor;
b) a memory associated with said processor;
c) a software system stored in said memory:
d) an input received by said software system, said input including legal matter information and quality information relating to said legal matter information;
e) a relational routine within said software system executed by said processor to relate said quality information to said legal matter information: and
f) an output generated by said processor, said output indicative of said quality information relating to selected legal matters.

2. The computer system of claim 1 wherein a comparison routine within said software is executed by said processor to compare said quality information for selected legal matters against comparison data comprising said quality information for other selected legal matters, quality rating outputs for other selected legal service providers, target quality information, benchmarked quality information and average quality information.

3. The computer system of claim 1 wherein said input received by said system includes cost information relating to said legal matter information and said relational routine within said software system executed by said processor relate said cost information to said legal matter information and said output generated by said processor is indicative of said cost information relating to selected legal matters.

4. The computer system of claim 1 wherein said software includes a statistical analysis routine executed by said processor to statistically analyze said quality information for selected legal matters and generate said output indicative of at least one statistical analysis comprising an average quality on said selected legal matters, a median quality on said selected legal matters, a highest and lowest quality rating on said selected legal matters, a standard deviation of quality on said selected legal matters and a count of said selected legal matters being analyzed.

5. The computer system of claim 1 wherein said software includes a categorizing routine executed by said processor to generate an output indicative of categorized quality information, categorized by at least one selected input comprising a service type, a legal service provider, a law firm, an attorney, an industry, a technology, a region where the law firm is located, a region where the work is being performed, a complexity rating of the legal matter.

6. The computer system of claim 5 wherein said software includes a categorized comparison routine executed by said processor to compare said quality information to at least one input comprising other said categorized quality information, an average of a plurality of said categorized quality information, a categorized benchmark of quality information and a categorized target of quality information.

7. The computer system of claim 1 wherein said legal matters are intellectual property matters comprising a patent matter, a trademark matter, a copyright matter, a trade secret matter and an intellectual property related opinion matter, an intellectual property related litigation matter, an intellectual property related contract matter, an intellectual property related investigation matter, an intellectual property related search matter, an intellectual property related watch matter, an intellectual property related appeal matter, an intellectual property related annuity matter, an intellectual property related merger and acquisition matter, an intellectual property related opposition matter and an intellectual property related renewal matter.

8. The computer system of claim 1 wherein said quality information in said input includes at least one quality rating from one or more quality reviewers comprising a patent attorney, an inventor, a patent translator, an employee of a company related to an assignee of a patent and a technical expert.

9. The computer system of claim 8 wherein said software includes a normalizing routine executed by said processor to normalize said quality rating by each individual reviewer relative to other quality reviewers such that said reviewer quality ratings are less subjective.

10. The computer system of claim 1 wherein said software includes a analytical routine executed by said processor to determine a time difference between an authorization date where a legal service provider is instructed to file a patent application and a filing date of said patent application, and said processor generates an output indicative of an average of said time difference for said legal service provider.

11. The computer system for assisting in the management of costs for legal matters comprising:
a) a processor:
b) a memory associated with said processor;
c) a software system stored in said memory:
d) an input received by said software system, said input including legal matter information and cost information:
e) a relational routine within said software executed by said processor that analyzes said input to relate said cost information to said legal matter information:
an analytical routine within said software executed by said processor that determines a time difference between a charge date associated with a specific charge and an initiation date associated with a specific legal matter, said charge date and said specific charge being included in said cost information and said initiation date and said specific legal matter being included in said legal matter information;
g) a categorizing routine within said software executed by said processor that categorizes a plurality of said specific charges and the time difference associated with said specific charges by at least a portion of said legal matter information; and
h) an output generated by said processor indicative of at least one said specific charge and said time difference associated with said specific charge, categorized by at least a portion of said legal matter information.

12. The computer system of claim 11 wherein said categorizing routine includes an averaging routine executed by said processor which uses said specific charge and said time difference associated with said specific charge to calculate a typical charge and an estimated date when said typical charge would be expected to occur.

13. The computer system of claim 12 wherein said software includes an identifying routine executed by said processor to identify a potential number of said specific legal matters which could potentially have charges during a selected time period after said initiation date.

14. The computer system of claim 13 wherein said software includes a normalizing routine executed by said processor to determine a ratio between said potential number of specific legal matters and a number of specific legal matters actually incurring said specific charges during said selected time period, and using said ratio generate an output that is indicative of a typical charge during said selected time period.

15. The computer system of claim 12 wherein said software includes a budget period routine executed by said processor which uses said typical charge and said estimated date, along with portions of said legal matter data as an input and generates an output indicative of an estimated future charge for at least one existing legal matter during a selected budget estimation time period.

16. The computer system of claim 12 wherein said software includes a legal matter budget routine executed by said processor which uses a plurality of said typical charges and said estimated dates as an input and generates an output indicative of an estimated total charge for a budgeted legal matter over the life of said budgeted legal matter.

17. The computer system of claim 16 wherein said software includes a sorting routine executed by said processor to generate an output indicative of a sorted total charge for a budgeted legal matter over the life of said budgeted legal matter, sorted by at least one selected input comprising a service type, a legal service provider, a law firm, an attorney, an industry, a technology, a region where the law firm is located, a region where the work is being performed and a complexity rating of the legal matter.

18. The computer system of claim 17 wherein said software includes a sorted comparison routine executed by said processor to compare said sorted total charge to at least one input comprising another of said sorted total charge generated by said computer system, an average of a plurality of said sorted total charges generated by said computer system, a benchmark for said sorted total charges and a target for said sorted total charges.

19. A method of evaluating legal service provider performance comprising the steps of:
a) using a computer system to receive and store input case information relating to legal matters;
b) using said computer system to receive and store input cost information relating to said legal matters, said cost information including actual legal costs;
c) using said computer system to determine each legal cost for individual legal matters during a cost sampling time period that is less than a typical life of said legal matters;
d) using said computer system to determine a time difference between an initiation date relating to each of said individual legal matters and a cost date relating to each said legal cost for the individual legal matters; and
e) using said computer system to analyze each said legal cost and said time difference associated thereto, to determine typical legal costs and estimated dates when said typical legal costs typically occur after the initiation date.

20. The method of claim 19 further comprising the steps of:
a) entering quality information relating to said legal matters into said computer system and
b) using said computer system to analyze said quality information such that a typical legal matter quality can be simultaneously reported with said typical legal costs.

21. The method of claim 19 further comprising the steps of
a) using said computer system to receive said typical legal costs and said estimated dates relating thereto as an input; and
b) using said computer system to estimate and report an estimate of future charges for at least one existing legal matter during a selected future budget period.

22. The method of claim 19 further comprising the step of using said computer system to evaluate said cost information during said cost sampling time period and to generate an estimate and a report of total legal matter costs over the typical life of a legal matter by summing typical legal costs over said typical life, said estimate based upon actual cost information in said computer system.

23. The method of claim 22 further comprising the steps of:
a) categorizing said estimate of total legal matter costs by at lease one input of a group comprising a service type, a legal service provider, a law firm, an attorney, an industry, a technology, a region where the law firm is located, a region where the work is being performed and a complex rating of the legal matter; and
b) comparing said categorized estimate of total legal matter costs to at least one input comprising another of said categorized estimate of total legal matter costs, an average of a plurality of said categorized estimate of total legal matter costs, a categorized benchmark of total legal matter costs and a categorized target of total legal matter costs.

24. The method of claim 23 further comprising the steps of:
a) analyzing said compared and categorized estimate of total legal matter costs by legal service provider to determine how said total legal matter costs for selected legal service providers compare to established costs; and
b) providing said selected legal service providers with a notification indicating how said total legal matter costs for said selected legal service provider compare to said established costs.

25. The method of claim 19 comprising the further step of a third party using said method to provide one or more services comprising: conducing analysis with said computer system, generating reports with said computer system, generating estimates with said computer system, conducting comparisons with said computer system, generating outputs with said computer system, offering output generated by said computer system to entities owning said legal matters, offering solutions to identified cost problems, offering solutions to identified quality problems, offering output generated by said computer system to legal service providers and performing quality reviews for selected legal matters.
